(19) United States
(12) Patent Application Publication
(10) Pub. No.: US 2025/0057713 A1
(43) Pub. Date: Feb. 20, 2025

(54) HYPERBARIC CHAMBER

(71) Applicant: Electroimpact, Inc., Mukilteo, WA (US)

(72) Inventors: Zory Taskar, Edmonds, WA (US); Peter B. ZIEVE, Seattle, WA (US); David Lawrence WILSON, Marysville, WA (US)

(21) Appl. No.: 18/809,319

(22) Filed: Aug. 19, 2024

Related U.S. Application Data
(60) Provisional application No. 63/520,527, filed on Aug. 18, 2023.

(51) Int. Cl. A61G 10/02

(52) U.S. Cl. CPC A61G 10/026; A61G 2203/70

(57) ABSTRACT

A monoplace hyperbaric chamber design to permit at least 2 ATR (about 30 psi relative) internal pressure which accommodates upright seating and, with stiffeners removed for transport, has dimensions to facilitate the chamber passing through a common door opening width of a doctor's examination room where the stiffeners are attached without disturbing a hermetic seal of the hyperbaric chamber.

### BACKGROUND

A hyperbaric chamber, in the present context, is a vessel that holds a person and which withstands a pressure greater than ambient pressure outside the vessel. These higher pressures can be regulated to address various ailments and/or to facilitate a procedure or treatment that requires, or is sped up by higher pressure. In some instances, a hyperbaric chamber may include facility to provide a gas or mixture of gasses different from the ambient environment (e.g., oxygen-enhanced air or pure oxygen). Hyperbaric treatments are known to benefit number of conditions, including at least decompression illnesses, gas embolisms, carbon monoxide poisoning, central retinal artery occlusion, diabetic wounds, necrotizing fasciitis, clostridial myositis and myonecrosis, certain crush injuries, compartment syndrome, intracranial abscess, and many more. In addition, some believe that hyperbaric oxygen treatments are useful for anti-aging purposes. Many such conditions are ideally treated with a pressure at or above two atmospheres relative (2ATR), translating to about 30 psi relative to ambient pressure.

Conventional chambers that will admit an adult patient and withstand such pressures have dimensions that will not permit the chamber to be installed in most conventional medical clinic suites, and as a result are either constructed in the facility where they will be used or relegated only to special facilities because they cannot be accommodated by a standard doorway or elevator in a typical clinical setting. More specifically, conventional hyperbaric chambers of a dimension and/or weight that can be accommodated by a typical examination room, having a door width of 36 inches or less, and that can be moved on a typical clinic elevator (commonly having a door width of 42 inches and a depth of 72 inches), are not sufficiently robust to handle pressures over about 1.4 ATR and are typically not configured (or configurable) to provide a whole-body, pure-oxygen environment that can be beneficial for treatments mentioned above. This limits the options for physicians that would offer hyperbaric treatments on-site but for the difficulty of placing an appropriate hyperbaric chamber.

### SUMMARY OF THE DISCLOSURE

In view of the challenges and limitations of conventional hyperbaric chambers, the applicant has devised a hyperbaric chamber that will facilitate 2ATR pressure (or 30 psi relative pressure), will fit a standard doorway and elevator, and does not require assembly of the pressure vessel on site.

### BRIEF DESCRIPTION OF THE FIGURES

FIG. 1 is a left-front perspective view of a hyperbaric chamber according to an embodiment;

FIG. 2A is a cutaway left-front perspective view of a hyperbaric chamber according to an embodiment;

FIG. 2B is close-up view of a portion of FIG. 2B, according to an embodiment;

FIG. 3 is an exploded right-front perspective view of the hyperbaric chamber of FIG. 1, according to an embodiment;

FIG. 4 is a back-right-bottom perspective view of a hyperbaric chamber, according to an embodiment;

FIG. 5 is a front view of a hyperbaric chamber according to an embodiment;

FIG. 6 is a right-side view of a hyperbaric chamber according to an embodiment (the left-side view is a mirror image of the right-side view);

FIG. 7 is a top view of a hyperbaric chamber according to an embodiment;

FIG. 8 is a rear view of a hyperbaric chamber, with door closed, according to an embodiment;

FIG. 9 is a top front oblique view of a hyperbaric chamber according to an embodiment;

FIG. 10 is a top rear oblique view of a hyperbaric chamber according to an embodiment;

FIG. 11 is a bottom front oblique view of a hyperbaric chamber according to an embodiment;

FIG. 12 is a front view of a hyperbaric chamber without added stiffeners, according to an embodiment;

FIGS. 13A and 13B are cross-sectional views of alternative stiffeners, according to an embodiment;

FIG. 14 illustrates a hyperbaric chamber arranged to admit a wheel-chair borne user, according to an embodiment;

FIG. 15 is a top view of an elevator car bearing a hyperbaric chamber according to an embodiment; and

FIG. 16 is a top view of a hallway accommodating a hyperbaric chamber according to an embodiment.

### DETAILED DESCRIPTION

The present disclosure describes embodiments of a hyperbaric chamber. The shape of the chamber is a cuboid or rounded rectangular prism defining a closed volume pressure vessel constructed chiefly of 0.375″ thick steel sheet. A removable exoskeleton of stiffeners may be employed to stiffen one or more walls of the chamber permitting a reduced weight of the chamber, compared to non-stiffened variants, without reducing accessibility of the unit both for users and those managing the chamber.

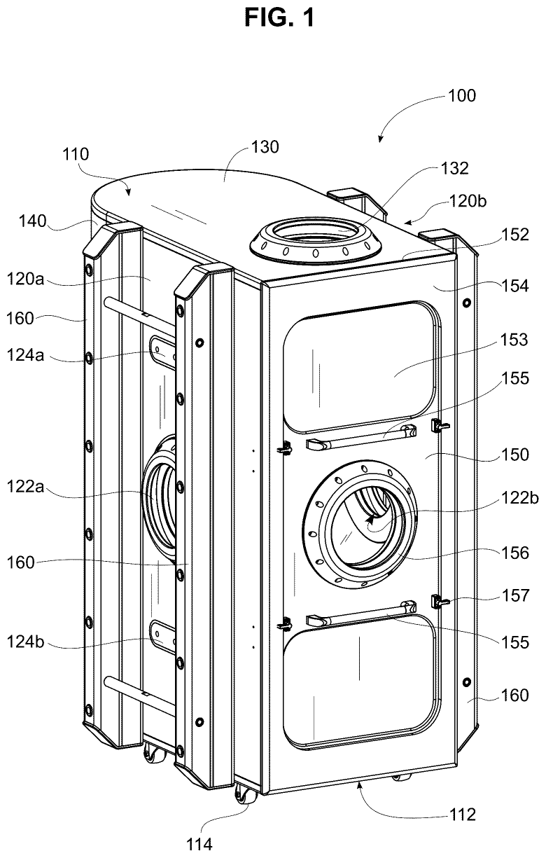

FIGS. 1-4 present various views of a hyperbaric chamber 100 that includes stiffeners according to a first embodiment. FIG. 1 is a perspective view of a hyperbaric chamber 100, according to an embodiment. The chamber 100 includes a base chamber 110 sized to permit entry of one seated user, and a door 150 movable to alternately open and seal against the base chamber 110. The base chamber 110 includes a bottom panel 112, two side panels 120a, 120b respectfully joined at edges thereof to respective opposite edges of the bottom panel 112, and a top panel 130 joined at opposite edges thereof to corresponding edges of the side panels 120a, 120b. Together the bottom panel 112, side panels 120a, 120b and top panel 130 define a rectangular opening 152 at a front of the base chamber 110. Opposite the door opening 152 the base chamber 110 includes a rear wall 140.

The bottom panel 112 may in some embodiments include wheels or casters 114 to facilitate movement of the chamber 100. In some embodiments the wheels or caster 114 may be adjustable, removable or retractable to facilitate leveling or stabilizing of the chamber 100 on an uneven surface, and/or to semi-permanently install the chamber 100. Further, the wheels or casters 114 may be lockable to prevent unintended movement of the chamber 100 when in use. In some embodiments, the door opening 152 may include a door frame 154. The bottom panel 112 may also include a ramp (e.g., 116 in FIG. 14) on the inside, outside, or both inside and outside of a bottom of the door opening 152 or door frame 154 to facilitate ingress/egress of a wheeled chair and/or to minimize trip hazards for ambulatory users.

Each side panel 120a, 120b may include a transparent window 122a, 122b sealed to the respective side panel to withstand the internal pressure of the chamber 100. At least one of the side walls 120a, 120b may include one or more port plates 124. Each port plate 124 may include one or more openings for safety valves, main or safe exhaust, bib controls, a main inlet, safety exhaust, etc. For example, in the illustrated embodiment, a first (top) port plate 124a on a left (hinge) side 120a of the chamber 100 may include one or more safety valves configured to relieve pressure in the chamber 100 if it rises above a predetermined threshold. A second (lower) port plate 124b on the left/hinge side 120a of the chamber 100 may include a main exhaust. A third (top) port plate 125a on the right, non-hinge side 120b of the chamber 100 may include bib controls constituting a console, such that the side 120b may be considered a “console side”. The right/console side 120b may also include a fourth, lower port plate 125b that includes a main inlet and safety exhaust. Each of the port plates 124, 125 may include additional openings (“penetrators”) to accommodate other ingress/egress of sensors, controls, etc. Those having skill in the art will acknowledge that various inputs/outputs may be interchanged, and/or that each side may have more or fewer port plates 124, 125.

The top panel 130 closes a top of the chamber 100. The top panel 130 may include a viewport 132, described in detail below.

The rear wall 140 may transition between the side panels 120a, 120b along a curve as illustrated, e.g., a semi-cylinder to enhance space and strength. The inventors recognize that shapes other than curved may be employed for the rear wall 140 within the scope of this disclosure.

The door frame 154 may be constructed of plate steel or other material selected to resist deflection under chamber pressures up to at least 2 ATR. In an embodiment the door frame may be formed from 0.75-inch-thick plate steel, and includes an opening configured to accommodate an access door 150. The access door 150 may similarly be constructed of a material selected for its resistance to deflection under pressure. For example, the access door may be formed primarily of 0.75-inch to 1-inch plate steel. The access door 150 may include one or more sections 153 milled or formed to a lesser thickness in order to, e.g., reduce weight of the door 150. According to an embodiment, the door 150 may be attached to door frame by two or more hinges, such as leaf hinges, and may be arranged to open inward into the chamber 100. In another embodiment, the access door 150 may be attached to an inner surface of a side wall (e.g., the left/hinge side 120a) of the chamber 100 by via said hinge(s) (not shown). The access door 150 may include a door gasket (not shown) such as, but not limited to, a pliable T-shape gasket disposed about a perimeter of the door access 150. The access door 150 may include one or more handles 155 to facilitate opening and closing the access door 150. The access door 150 may include a plurality of securing mechanisms 157, such as turn latches as illustrated, configured to hold the access door 150 sealed against the door frame 154 when in a closed position. The access door 150 may include a viewport 156.

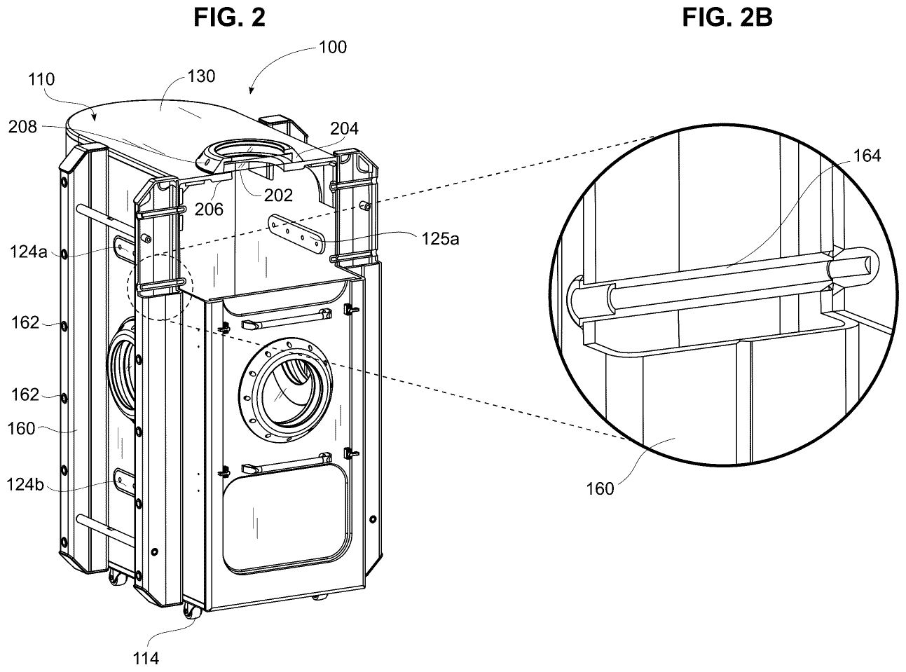

According to an embodiment, viewports 122a, 122b, 132 and 156 may all have the same form and dimensions. Those having skill in the art will recognize that a plurality of viewports may have respectively different dimensions and/or shapes so long as the viewport accommodates sufficient space within the chamber 100 and will withstand pressures of up to at least 2 ATR without leaking. For example, each of the viewports (also referred to generally herein as windows) may include an acrylic window 202 of, e.g., 1.75-inch thickness (seen in cutaway, for example, in FIG. 2A). The window 202 may be held against a perimeter of an opening in its respective wall by a viewport encasement 204 disposed about a perimeter of the window 202. A gasket (not shown) may be disposed between the viewport casement 204 and the window 202. On an opposite side of the wall (120a, 120b, 130) or door 150 from the window 202 and viewport casement 204, a viewport plate 206 may be fixed (e.g., welded) to the wall/door. The viewport casement 204 may be fixed to the wall/door by a plurality of bolts 134 via bolt holes in the viewport casement 204 and bolt holes 136 in the wall/door. While the figures illustrate the viewport casement 204 and windows 202 on an exterior of the chamber 100 and the viewport plate 206 on an exterior surface, those having skill in the art will recognize that the viewports can be fixed from an interior side in some embodiments, with the viewport plate 206 on the exterior surface. However, it will be acknowledged that removal of the viewport casement 204 and window 202 on each side 120a, 120b will reduce the overall width of the chamber to accommodate passage of the chamber 100 through narrow doorways, whereas an interior mounting of the window 202 and viewport casement 204 would require a viewport plate weldment on the exterior surface in some embodiments, reducing interior space.

The chamber 100 may include one or more modular stiffeners 160 respectively corresponding to walls of the base chamber 110. Each modular stiffener 160 is configured to be removable and/or foldable against its corresponding wall to reduce width of the base chamber 100. For example, as shown in FIGS. 1-4, each side of the base chamber 110 may include two modular stiffeners 160 disposed on either side of the viewports 122a, 122b.

FIG. 2A is a partial cutaway view of the chamber 100 in FIG. 1, according to an embodiment. The cutaway portion shows the chamber 100 with an upper section of the door 150 and door frame 154 and cross-sections of the stiffeners 160 on either side wall 120a, 120b. The modular stiffeners 160 may be removably fixed across sides 120a, 120b of the chamber 100. The modular stiffeners 160, according to an embodiment, may be formed from rectangular tubing and fixed to the base chamber 110. Those having skill in the art will acknowledge other shapes or bars used as modular stiffeners. A plurality of bolts 162 may be disposed through a plurality of bolt sleeves 164 in the modular stiffeners 160. FIG. 2B shows a closeup view of a representative bolt sleeve/hole 164 in a stiffener 160 with the bolt 162 removed.

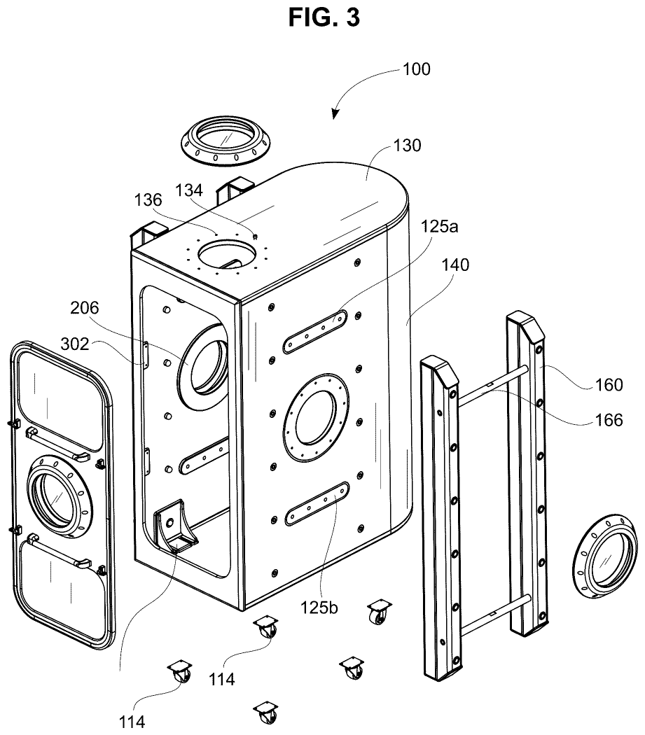

FIG. 3 is an exploded right-front perspective view of the hyperbaric chamber 100 of FIG. 1, according to an embodiment. The exploded view permits a better view of the hinges 302, the weldment and attachment holes 136 for the view plates 206, and an arrangement of the modular stiffeners 160, including a cross bar 166 disposed between two modular stiffeners 160. The crossbar 166 may facilitate handling of the chamber 100, provide a safety feature for certain users, and may permit convenient placement of various equipment, etc.

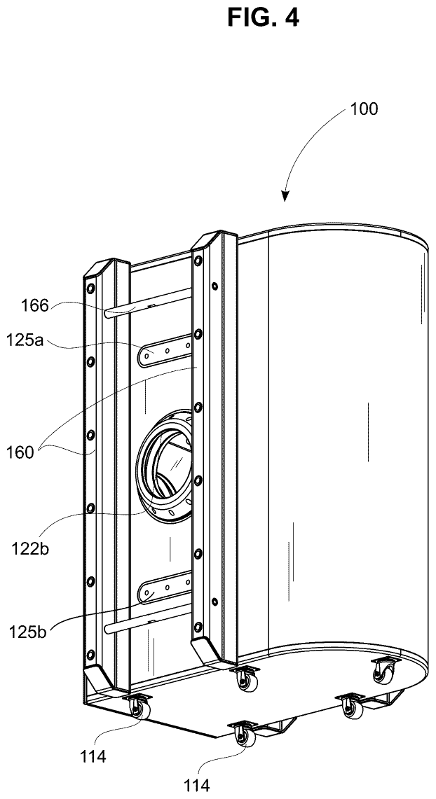

FIG. 4 is a back-right-bottom perspective view of a hyperbaric chamber 100, according to an embodiment. Locations for attachment of casters 114 are seen, as well as a clearer view of the third and fourth (right side) port plates 125a, 125b.

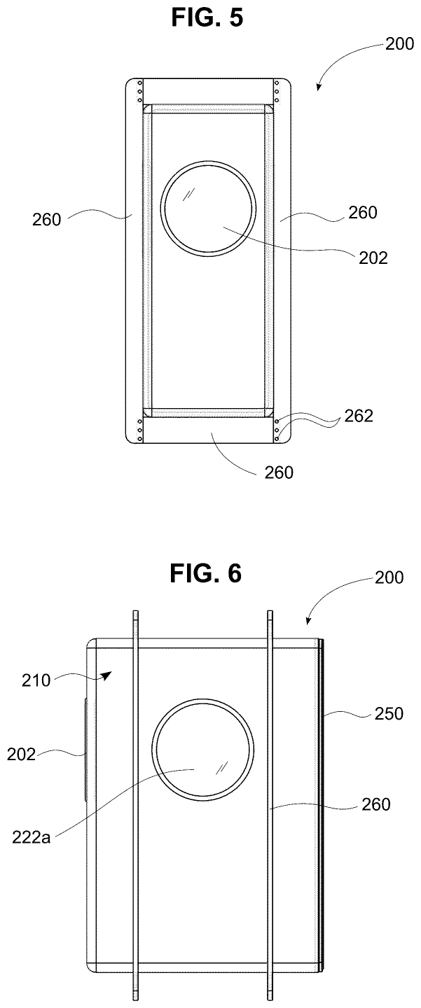

FIGS. 5-11 present various views of a hyperbaric chamber 200 that includes stiffeners 260 surrounding the chamber on top, sides, and bottom, according to another embodiment.

FIG. 5 shows a front view of hyperbaric chamber 200, including a window 202, according to an embodiment. The window 202 (referenced alternatively as a “viewport” elsewhere herein) permits a user to see the outside environment, communicate, and permits a treatment observer to check on the person being treated=. It will be acknowledged that the chamber 100 discussed above includes a viewport in the access door 150, suggesting that the person being treated may sit facing toward the door, whereas in the chamber 200 there is a window 200 in the front wall opposite the door, suggesting that the person being treated may face away from the door. In some implementations, one arrangement may be preferable to another for user comfort, ease of ingress/egress, or the like. Although the figures show a round window, the inventor acknowledges that other windows shapes capable of withstanding the pressures of the chamber may be employed within the scope of this disclosure. For example, an oval window may be used in an embodiment.

Stiffeners 260 may, according to an embodiment, surround the monoplace hyperbaric chamber 200 such that the horizontal members (top, bottom) may hold the vertical members in place, and vice versa. In this embodiment, the stiffeners 260 may rely on only the structure of the stiffeners to resist deflection, being connected at ends by bolts or rivets 262. Alternatively, the stiffeners may be fixed to the chamber similar to the description above for the chamber 100 (e.g., using blind holes formed in the walls of the chamber), or connecting to weldments along the respective walls. Similar to the description above, the stiffeners 260 may be removed while moving/placing the chamber 200. In some embodiments, the stiffeners 260 may be hingedly attached to the chamber such that they can be laid flat against the respective sides, permitting the chamber to move through a narrower doorway than would be otherwise possible.

FIG. 6 is a right-side view of the hyperbaric chamber 200 according to an embodiment. As can be appreciated from the figure, the stiffener bars at the bottom in this embodiment may elevate the bottom of the hyperbaric chamber by the width of the stiffener bar. In some embodiments the right and left sides of the hyperbaric chamber may be mirror images of each other. For example, both sides may respectively include a window 222 configured to withstand the pressure in the chamber. In some embodiments neither side, or only one side may include a window.

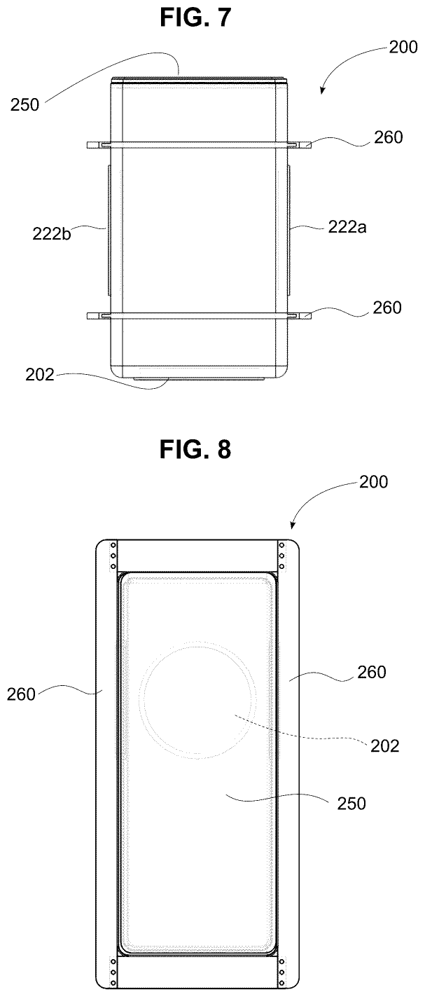

FIG. 7 illustrates a top view of the hyperbaric chamber including stiffener bars 260. Although no top window is illustrated in the figure, those having skill in the art will appreciate that a window may be disposed in a top panel to admit light, accommodate communication, etc.

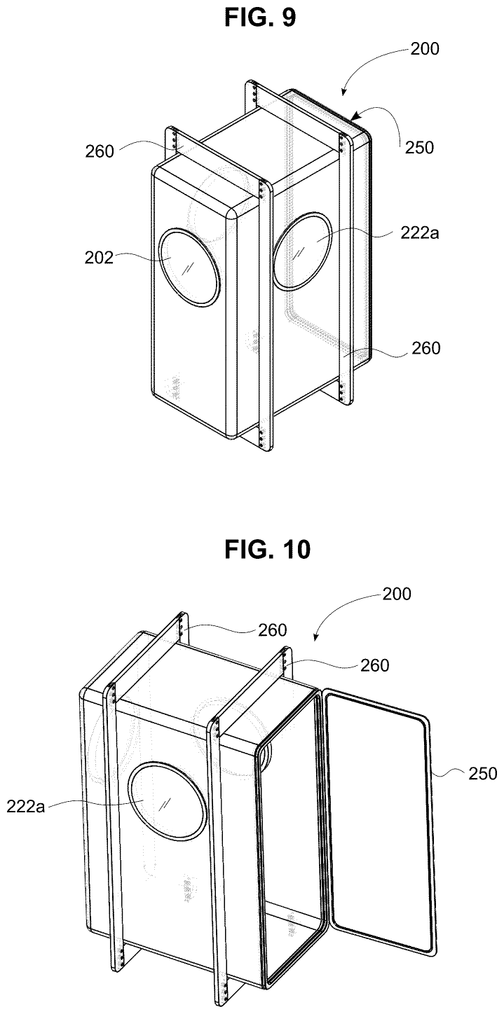

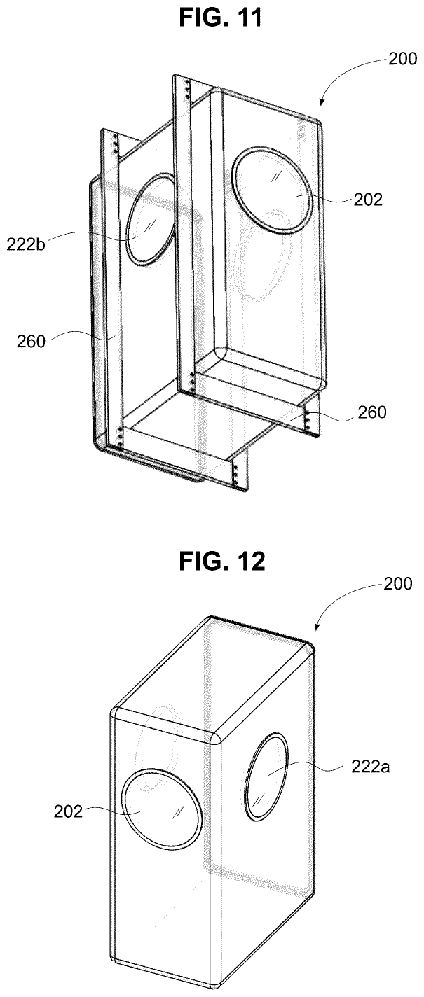

FIG. 8 is a back view of a hyperbaric chamber 200, with door 250 closed, according to an embodiment. As shown the 250 door may in some embodiments reach the full width and height of the chamber. In other embodiments, the front of the chamber may include a frame to which the door may be attached, a sealing feature, or the like. For example, the door frame may include a lip and/or gasket against which the door seals. Alternatively or additionally, the door itself may include a gasket, lip and/or the like to facilitate an airtight seal. FIG. 9 is a top front oblique view of the hyperbaric chamber 200 according to an embodiment. FIG. 10 is a top rear oblique view of the hyperbaric chamber 200 according to an embodiment. FIG. 11 is a bottom front oblique view of the hyperbaric chamber 200 according to an embodiment.

While FIGS. 5-11 show two stiffener bar assemblies each surrounding the hyperbaric chamber, the applicants anticipate that certain embodiments may include fewer or more stiffener bars 260. FIG. 12, for example, illustrates a hyperbaric chamber without stiffener bars, but otherwise analogous to the hyperbaric chamber described with respect to FIGS. 5-11.

According to an embodiment, the chamber 200 may be fabricated from 0.375″ thick steel. Despite the use of robust materials in the base chamber, this structure may in some circumstances deform under the working pressure of 2 ATR or more (about 30 psi or more relative to ambient pressure). To supplement resistance to the required pressure, external stiffener bars may be applied to one or more exterior surfaces of the cuboid vessel. According to an embodiment, a stiffener may be formed by a six-inch bar steel which may be mounted about the exterior of the chamber after the chamber has been set in its place of operation (e.g., the physician examination room). Such external stiffener bars can be employed on one or as many as all six exterior surfaces as required. The surfaces most likely to need the aid of external stiffener bars (and thereby invoke this invention) are the large side panels of, e.g., 53 wide×80 high.

The stiffener bars 260 may be formed in a number of ways. As illustrated in FIGS. 5-11, the stiffener bars 260 may be formed of plate steel. In some embodiments such steel stiffeners may be ⅛″ thick, 6″ wide, and have a length at least as long as the respective side to which it corresponds. As noted above, the stiffeners may be formed in sections corresponding to the sides of the chamber. A set of stiffener bars 260 may be affixed to each other to form a band around the chamber 200. For greatest resistance against deformation, the stiffener bar 260 may be mounted such that the width of the bar extends away from the respective walls as shown in FIGS. 5-11. In other embodiments (e.g., FIGS. 1-4) the stiffeners may be affixed directly the corresponding surface of the chamber, e.g., by bolts, screws, or the like. In some embodiments, at least the stiffeners corresponding to left and right sides of the chamber may be attached in a manner that permits those stiffeners 260 to be temporarily removed or moved into a position that reduces overall width of the assembly. For example, at least side-wall stiffeners 260 may be attached in a manner that the stiffener bar 260 can be folded against the side wall, e.g., using a hinge or the like, so that the overall width of the combustion chamber is reduced for ingress/egress through a doorway or elevator. Other geometries may be employed for the stiffeners without departing from the disclosure, such as tubing having rectangular, circular or triangular cross-section.

In some embodiments, one or more resilient elements may be disposed between the stiffener bar and the corresponding surface. For example, a strip of foam or rubber or the like may be inserted to reduce sounds of metallic strain when the chamber is being pressurized or depressurized.

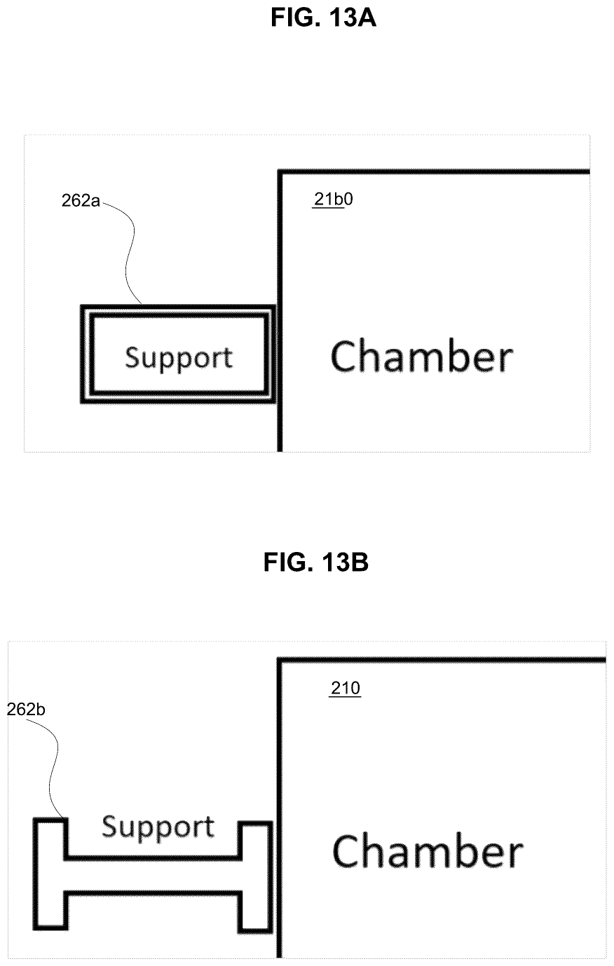

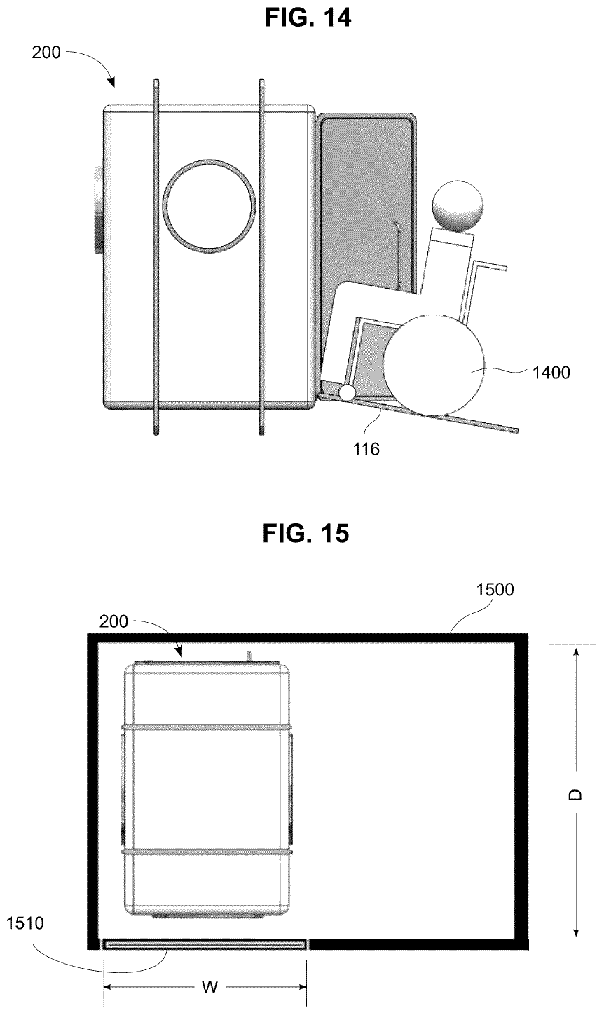

FIG. 13A is a cross-sectional top view of a stiffener 262a formed from rectangular tubing, according to an embodiment. As shown the figure, the rectangular tubing 262a may have its short dimension placed against the corresponding wall of the hyperbaric chamber 202. Although this orientation provides the greatest rigidity versus expansion of the corresponding chamber wall, Applicant recognizes that the stiffener 262a may, in some implementations, be sufficiently strong when oriented to have the longer dimension of the rectangular cross section disposed against the corresponding wall of the hyperbaric chamber 210. FIG. 13B is a cross-section view of a stiffener 262b formed from an I-beam, in which the bottom of the “I” is disposed against a corresponding wall of the chamber 210.

A doorway 250 may be formed as the back, or part of the back, of the hyperbaric chamber. A doorway permits a user/patient to enter or be placed inside the chamber 200, e.g., facing the front window 202. Once occupied, the chamber door 250 may be closed, and the chamber 210 may then be pressurized. According to some embodiments, the chamber door 250 may be configured to open outward, and a sealing mechanism, e.g., as described above for the first embodiment, may bias the door 250 against the chamber 210 when in the closed position. Applicant also considers embodiments (not shown) in which the door 250 may open inwardly. In this case the pressure inside the chamber 210 will bias the door 250 such that it presses against a door seal. In this case, the greater the pressure, but tighter the air seal. Although not shown, the door itself may include a window in some implementations (such as in the first embodiment.

FIG. 14 illustrates a hyperbaric chamber arranged to admit a wheel-chair borne user, according to an embodiment. The door of the chamber 200 may be formed having a width to accommodate a standard wheelchair 1400. In some implementations, the door of the chamber may be formed wide enough to accommodate a large wheelchair, e.g., for bariatric patients. The hyperbaric chamber may include a ramp 116, ramp holders (not shown), and/or rails (not shown) to guide a wheelchair 1400.

The hyperbaric chamber according to the disclosure may be pressurized with up to at least 2 ATA (30 psi relative to atmospheric pressure) of pure oxygen according to an embodiment. In other embodiments, the chamber 200 may be pressurized with ambient air. A typical treatment time may be one hour for a session, to at least partially address a given malady. However, other treatment times can be accommodated. For example, 15 minutes, 30 minutes, 45 minutes, 1.5 hours 2 hours, or more, depending on treated condition, user tolerance, and the like.

The hyperbaric chamber 100, 200 is designed so that the pressure vessel can be manufactured and/or assembled and tested prior to installation at an end destination. This permits the base chamber to remain intact after initial factory assembly to minimize assembly errors and the potential dangers/risks that can result. It is important that the chamber remain intact after factory assembly to minimize assembly error and maximize pressure testing efficiency.

The dimensions and weight of the disclosed cuboid vessel, and the resulting access to typical medical clinic examination rooms unlocks a critical market for physicians that would otherwise have no choice but to refer patients to a specialized treatment center. In some embodiments, a disclosed pressure vessel may include features to facilitate movement of the vessel, such as wheel casters, rollers, or the like. In other embodiments, a dolly may facilitate movement of the chamber 100, 200.

To pass through the door opening the chamber width is no greater than 36 inches and the height must be less than 84 inches. To accommodate smaller doors, the chamber may be constructed having a width of approximately 30 inches according to an embodiment. The height of the chamber on casters may be 80 inches or less. Notably, at 80 inches, a chamber may accommodate one or more standing occupants. In some embodiments, the height of the chamber may be limited to accommodate the height of a seated occupant, for example, 60 inches or less. In some instances, an office may desire different size models to accommodate different comfort preferences of patients.

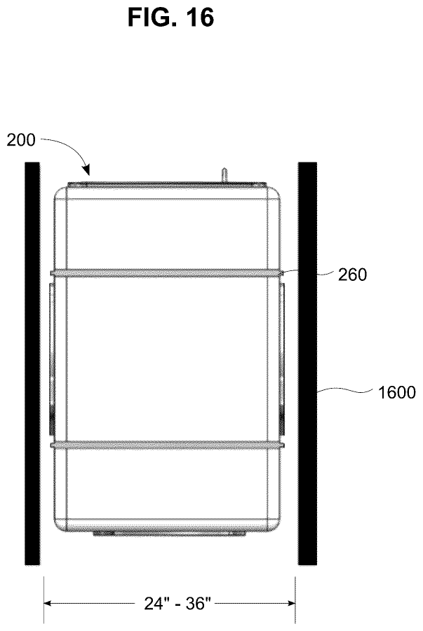

According to an embodiment, the length of the chamber may be chosen to accommodate a hallway or other passage leading to the examination room placement such that the chamber can be maneuvered into a position to access the doorway. For example, FIG. 16 is an overhead view of a chamber 200, according to a disclosed embodiment, the chamber 200 being in a narrow hallway 1600 and having the side stiffeners 260 removed or folded to reduce width of the chamber 200. The chamber must be oriented across the width of a hallway or passageway area outside the door in order to maneuver the chamber through the door.

Similarly, FIG. 15 illustrates an elevator 1500 having a door 1510 of width W and depth D. The depth of an elevator used for transporting the chamber to a desired floor of the building in which the chamber is placed may also limit the depth dimension of the chamber. In some jurisdictions, minimum elevator size is dictated by law for particular purposes. For example, the government of New York City specifies a size and weight capacity for a smallest elevator (https://www.nyc.gov/assets/buildings/bldgs_bulletins/bb_2011-018.pdf). According to an embodiment, the length of the chamber 200 may be limited to 53 inches or, in another embodiment, 60 inches. However, if a physician's office or clinic requires a shorter length due to narrower passageways, a chamber can be constructed according to the present disclosure having a shorter length. Applicant notes, however, that in some circumstances a longer length may be appropriate in instances where space permits. For example, a longer length may permit usage by more than one person at time, such as two patients facing each other. Such longer length may permit a parent and child or a patient and support partner to simultaneously use the chamber while still permitting the chamber to enter a sufficiently large exam room through a common door width.

According to an embodiment, the chamber may include four vertical side walls. At least one of the vertical side walls of the chamber may feature a door which can open and close to allow access by a user/patient. The door and a corresponding opening of the chamber are mutually configured to be sealed against each other when the door is in a closed state to resist unintended loss or gain of gas pressure inside the chamber.

At least one vertical side wall surface of the chamber may feature a window sealed against a corresponding opening of the vertical side wall surface and is configured to resist internal pressure. Both the door and window(s) may be structured and oriented to facilitate accessibility of the chamber into the physician examination room. For example, according to an embodiment, each window may include a frame and/or sealing structure that protrudes away from the corresponding vertical wall surface. In such embodiment, the frame and/or sealing structure may be installed such that that its protrusion is chiefly directed toward the interior of the chamber to avoid unnecessarily adding to the overall width or length of the chamber, compared with the protrusion being directed outward, while ensuring that the chamber width and/or length is less than a doorway width and/or elevator depth.

According to an embodiment, the chamber may include openings to accommodate airtight connections for oxygen/air supply, external exhaust, controls, audio, and/or power. The applicant recognizes that venting of high-concentration oxygen can be a safety hazard. Accordingly, the chamber may include sealable openings for input of oxygen (or in some embodiments, compressed air) up to 2ATR (30 psi relative pressure). The openings may also permit safe and pressure-tolerant access for pneumatic and/or electrical controls, lighting, etc. The chamber may further provide an exhaust exit to accept a valved or otherwise control exhaust of pressurized oxygen or air at the end of a session. The openings may be designed for adherence to safety protocols to prevent the venting of pure oxygen into closed spaces. In some embodiments, the chamber may facilitate or incorporate a gas recirculation mechanism in which gasses from the interior of the chamber are filtered or scrubbed to remove non-oxygen elements such as CO₂, to maintain the high- or pure-oxygen treatment and not avoid toxic buildup of CO₂, nitrogen and/or other components of the interior gas environment.

What is claimed is:

1. A hyperbaric oxygen therapy chamber, comprising:
a base chamber having a top wall, bottom wall, a first side wall, a second side wall disposed opposite the first side wall, and a third side wall, the third side wall disposed between an edge of the first side wall and an edge of the second side wall, the bottom wall having a width dimension between 24 and 36 inches and a depth dimension less than 72 inches, the first, second and third side walls having a height dimension between 40 and 84 inches, the top and bottom walls, first side wall, second side wall and third side wall together defining a volume;
a door panel disposed as a fourth side wall to close the volume, the door panel defining a doorway opening and having an access door configured to selectably open and close against the doorway, at least one of the access door and the door panel having a securing mechanism configured to temporarily secure the access door against the doorway opening when the access door is in a closed position against the doorway opening;
a sealing feature disposed about a perimeter between the door panel and the access door, the sealing feature and securing mechanism configured to prevent loss of pressure in the base chamber of at least 30 psi relative or 2 atmospheres relative (ATR) when the access door is secured in the closed position; and
one or more modular stiffeners respectively corresponding to at least one of the first side wall, the second side wall, the top wall, and the bottom wall of the base chamber, each modular stiffener being removable and/or foldable against its corresponding first side wall, second side wall, top wall, or bottom wall to reduce width of the base chamber,
wherein the top wall, the bottom wall, the first side wall, the second side wall, the third side wall, and the door panel together form an airtight vessel.

2. The hyperbaric oxygen therapy chamber according to claim 1, wherein the third side wall is curved to stiffen and reduce pressure distortion of the base chamber.

3. The hyperbaric oxygen therapy chamber according to claim 2, wherein when the one or more modular stiffeners include at least one first-side modular stiffener and at least one second-side modular stiffener respectively configured for secure attachment to the first side wall and the second side wall, the secure attachment including one or more fasteners attached to or through the first-side modular stiffener and the first side wall and one or more fasteners attached to or through the second-side modular stiffener and the second side wall, each of the fasteners maintaining hermetic integrity of the base chamber.

4. The hyperbaric oxygen therapy chamber according to claim 3, wherein the secure attachment of the at least one first-side modular stiffener and the at least one second-side stiffener includes respective blind-tapped holes in the first side wall and the second wall that do not disturb the hermetic integrity of the base chamber.

5. The hyperbaric oxygen therapy chamber according to claim 1, wherein the interior volume is dimensioned and arranged to accommodate an upright seating position of a user.

6. The hyperbaric oxygen therapy chamber according to claim 1, wherein the chamber incorporates an integrated upright seat.

7. The hyperbaric oxygen therapy chamber according to claim 5, wherein the size and shape of the access door when open, permits rolling access of a wheeled chair.

8. The hyperbaric oxygen therapy chamber according to claim 1, wherein at least one of the first side wall, the second side wall, the third side wall, the access door, and the top wall includes a pressure resistant viewport.

9. The hyperbaric oxygen therapy chamber according to claim 1, further comprising a plurality of wheel casters removably attached to the bottom side of the cuboid vessel.

10. A process for moving the hyperbaric oxygen therapy chamber of claim 1, the method comprising:
separating the one or more modular stiffeners from at least the first side wall and the second side wall the base chamber of the hyperbaric oxygen therapy chamber;
moving the base chamber through a doorway having a width of 24 to 37 inches;
placing the base chamber in a use location,
securing the separated one or more modular stiffeners to the at least first side wall and second side wall of the base chamber using one or more fasteners attached to or through a first modular stiffener of the one or more modular stiffeners and the first side wall and one or more fasteners attached to or through a second modular stiffener of the one or more modular stiffeners and the second side wall, each of the fasteners maintaining hermetic integrity of the base chamber.
